(19) United States
(12) Patent Application Publication
(10) Pub. No.: US 2013/0260168 A1
(43) Pub. Date: Oct. 3, 2013

(54) COMPONENT HOLE TREATMENT PROCESS AND AEROSPACE COMPONENT WITH TREATED HOLES

(71) Applicants: Donald Charles Slavik, Cincinnati, OH (US); Bernard Harold Lawless, West Chester, OH (US); Robert Hugh Van Stone, Cincinnati, OH (US); Gerald Roger Geverdt, Cincinnati, OH (US)

(72) Inventors: Donald Charles Slavik, Cincinnati, OH (US); Bernard Harold Lawless, West Chester, OH (US); Robert Hugh Van Stone, Cincinnati, OH (US); Gerald Roger Geverdt, Cincinnati, OH (US)

(73) Assignee: General Electric Company, Schenectady, NY (US)

(21) Appl. No.: 13/434,320

(22) Filed: Mar. 29, 2012

(51) Int. Cl. C21D 7/06; B32B 3/24

(52) U.S. Cl. 428/596; 72/53; 428/131

(57) ABSTRACT

A method of treating a hole in a metallic component includes the following steps in sequence: forming an hole having a first diameter in the component; expanding the hole to a second diameter using a cold expansion process, so as to induce residual compressive stresses in the material surrounding the hole; shot peening the hole; and final machining the hole to a finished diameter.

### BACKGROUND OF THE INVENTION

This invention relates generally to aerospace components and more particularly to manufacturing methods for holes in aerospace components.

Aerospace components such as gas turbine engines include numerous metallic components having bores and/or holes formed therein to accept fasteners or for other purposes. In operation these components are subject to vibration and cyclically reversed loadings which can lead to crack initiation and component failure. Of particular interest in these components is low cycle fatigue life (generally defined as approximately less than 50,000 cycles).

Low cycle fatigue life can be increased by improving material capability, reducing component local stresses, or introducing compressive residual stresses. Reducing local stresses is possible with component geometry changes, but this approach can be impractical or add component weight making it undesirable for aircraft engine applications.

Introduction of compressive residual stresses in components improves low cycle fatigue life. There are a number of known methods to introduce compressive residual stresses. Split sleeve cold expansion and/or shot peening introduce compressive surface stresses to improve fatigue life, but these approaches alone may not improve fatigue crack initiation life for elevated temperature applications. Roller burnishing introduces compressive residual stresses, but the current process may not be well controlled with a reduced benefit at elevated temperatures. Low plasticity roller burnishing or laser shock peening introduce compressive residual stresses that are retained up to elevated temperatures, but these approaches require specialized tooling and/or monitoring software to ensure proper amounts of residual stress is introduced in the components.

Accordingly, there is a need for a hole treatment process which can use conventional manufacturing tools and which is well controlled.

### BRIEF SUMMARY OF THE INVENTION

This need is addressed by the present invention, which provides a method of hole treatment including split sleeve cold expansion combined with subsequent material removal, shot peening, and post-peening material removal to a finished hole diameter.

According to one aspect of the invention, a method of treating a hole in a metallic component includes the following steps in sequence: forming a hole having a first diameter in the component; expanding the hole to a second diameter using a cold expansion process so as to induce residual compressive stresses in the material surrounding the hole; shot peening the hole; and final machining the hole to a finished diameter.

According to another aspect of the invention, an aerospace component includes at least one hole formed therein, the hole formed by the following steps in sequence: forming a hole having a first diameter in the component; expanding the hole to a second diameter using a cold expansion process so as to induce residual compressive stresses in the material surrounding the hole; shot peening the hole; and final machining the hole to a finished diameter.

### BRIEF DESCRIPTION OF THE DRAWINGS

The invention may be best understood by reference to the following description taken in conjunction with the accompanying drawing figures in which:

FIG. 1 is half-sectional schematic view of a gas turbine engine;

FIGS. 2A and 2B are sectional and front elevation views, respectively, of a component undergoing a drilling process;

FIGS. 3A and 3B are sectional and front elevation views, respectively, of a component undergoing a reaming process;

FIGS. 4A and 4B are sectional and front elevation views, respectively, of a component undergoing a cold working process;

FIG. 4C is an enlarged view of a portion of FIG. 4B;

FIGS. 5A and 5B are sectional and front elevation views, respectively, of a component undergoing a reaming process;

FIGS. 6A and 6B are sectional and front elevation views, respectively, of a component undergoing a shot peening process; and

FIGS. 7A and 7B are sectional and front elevation views, respectively, of a component undergoing a post-peen material removal.

### DETAILED DESCRIPTION OF THE INVENTION

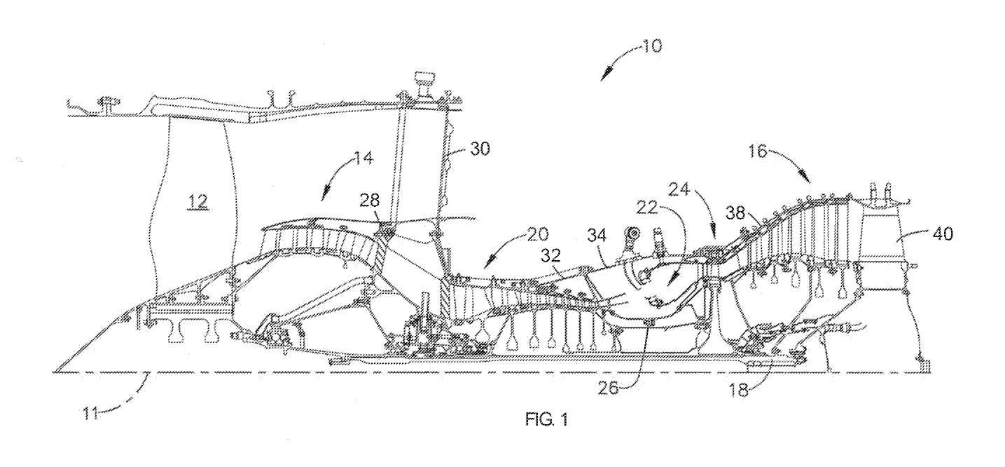

Referring to the drawings wherein identical reference numerals denote the same elements throughout the various views, FIG. 1 depicts a gas turbine engine 10. The engine 10 has a longitudinal axis 11 and includes a fan 12, a low pressure compressor or “booster” 14 and a low pressure turbine (“LPT”) 16 collectively referred to as a “low pressure system”. The LPT 16 drives the fan 12 and booster 14 through an inner shaft 18, also referred to as an “LP shaft”. The engine 10 also includes a high pressure compressor (“HPC”) 20, a combustor 22, and a high pressure turbine (“HPT”) 24, collectively referred to as a “gas generator” or “core”. The HPT 24 drives the HPC 20 through an outer shaft 26, also referred to as an “HP shaft”. Together, the high and low pressure systems are operable in a known manner to generate a primary or core flow as well as a fan flow or bypass flow. While the illustrated engine 10 is a high-bypass turbofan engine, the principles described herein are equally applicable to turboprop, turbojet, and turboshaft engines, as well as turbine engines used for other vehicles or in stationary applications.

The engine 10 includes numerous metallic components having bores and/or holes formed therein to accept fasteners or for other purposes. Nonlimiting examples of such components include the fan frame 28 and struts 30, compressor casing 32, combustor casing 34, LPT casing 38, turbine rear frame 40, and HP rotor (i.e. the shaft 26 and other components rotating with it). Those components may be manufactured from known aerospace materials such as steel, cobalt, titanium alloys, and nickel based alloys including “superalloys.” An example of a specific alloy that several of the components described above may be made from is a nickel-based precipitation-hardenable alloy commercially known as INCONEL 718 (IN718) or direct aged 718 (DA718). The invention will be further described below with respect to a generic component “C”, with the understanding that the component “C” is representative of the above-listed components or any other metallic component having bores or holes formed therein.

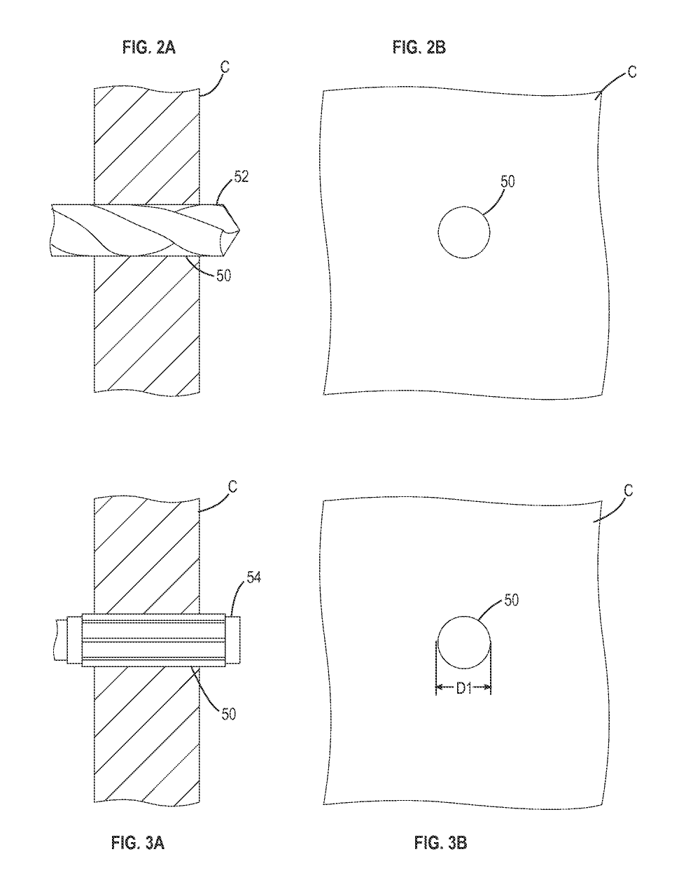

One or more holes are formed in the component C and subsequently treated as follows: Initially, (see FIGS. 2A and 2B) a hole 50 is formed in the component C. In the illustrated example a twist drill 52 is shown forming the hole 50. Nonlimiting examples of other suitable hole-forming processes include, boring, laser drilling, electrodischarge machining (“EDM”), or electrochemical machining (“ECM”). The hole 50 may be finish machined using a reamer 54 or other suitable tool as shown in FIGS. 3A and 3B. After these processes, the hole 50 has a diameter “D1” that is undersized compared to the final required diameter.

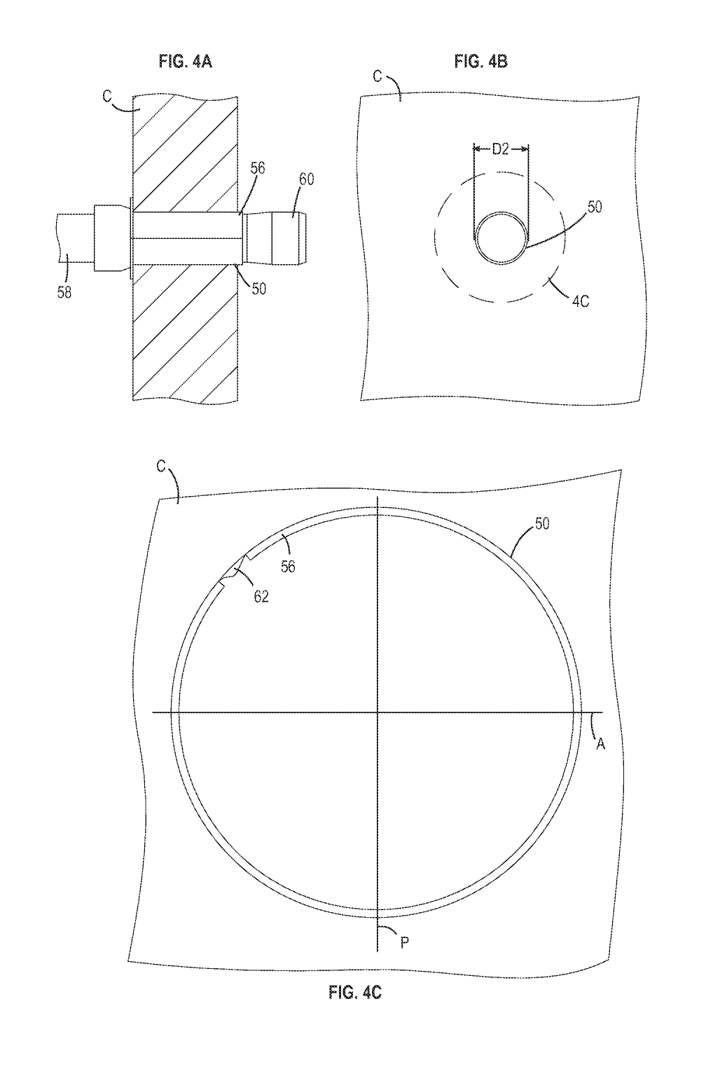

Next, (see FIGS. 4A and 4B), the hole 50 is treated using cold expansion (“CE”). In the specific example illustrated, the process is split-sleeve cold expansion (“SSCE”). This is a known process in which a generally cylindrical sleeve 56 with a single longitudinal split is inserted into the hole 50. A mandrel 58 that includes a head 60 with an enlarged cross-section is then pushed or pulled through the sleeve 56. The mandrel 58 expands the sleeve 56 radially outwards against the bore of the hole 50.

The SSCE process expands the hole 50 to a larger diameter “D2” and cold-works the material around the hole 50 to induce residual compressive stresses therein. An exemplary increase in the hole diameter from D1 to D2 is about 4%. As used herein, the term “CE” is intended to refer to any mechanical process which cold-works the hole 50 and would also encompass processes using sleeves with two or more splits, shape-memory-type sleeves lacking any splits, or adjustable expanding mandrels. This step significantly improves the crack propagation life of the hole 50.

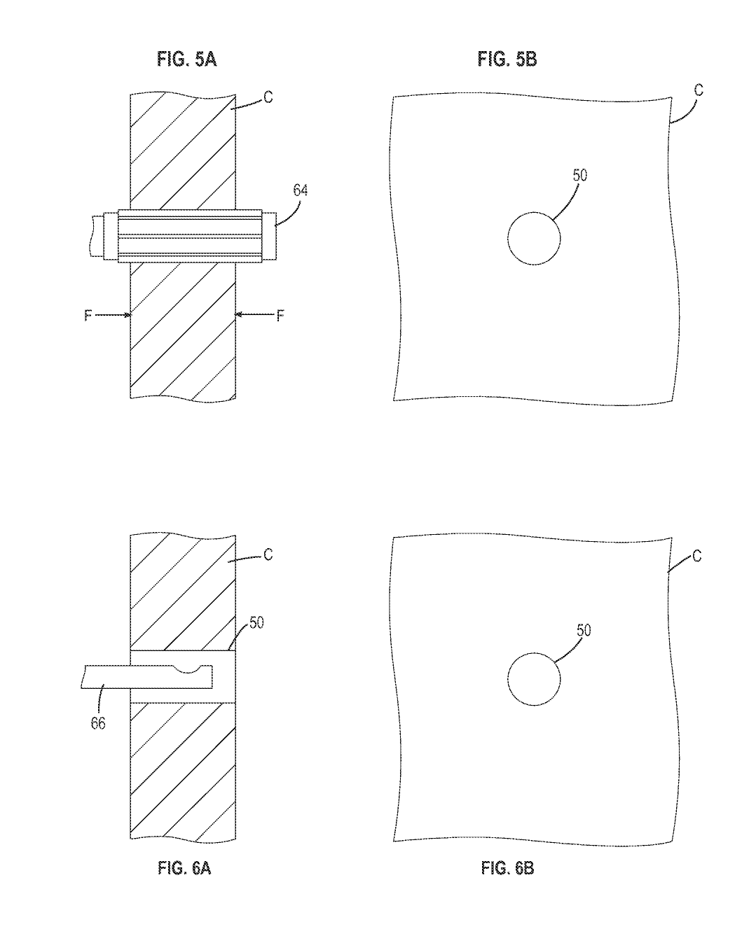

The plastic strains of the SSCE process with a split sleeve creates a small extruded ridge 62 of “bulged material” in the hole 50 at the location of the sleeve split line as seen in FIG. 4C. The material properties of the component C may be different at the sleeve split line and could be inferior to the material properties around the rest of the hole 40. In operation, the hole 50 will experience peak stresses at two diametrically-opposed positions along a line “P” and also at two diametrically-opposed positions along a line “A” oriented 90 degrees to the line P. The location of the lines “P” and “A” would be known at the time of manufacturing the component C based on predicted operating loads (for example, the hole 50 might lie along a line of similar holes in a rotating disk). Locating the split at approximately 45 degrees from the peak stress locations as depicted in FIG. 4C does not adversely impact the component fatigue life. The extruded ridge may be removed using a conventional reamer 64 or other suitable method as seen in FIGS. 5A and 5B. The outer faces “F” of the component C surrounding the hole 50 may be machined flat, and the ends of the hole 50 may be chamfered.

Next, the hole 50 is subjected to shot peening, as seen in FIGS. 6A and 6B. Shot peening is a known process in which a stream of small spheres (such as steel, glass, or ceramic shot) is directed under pressure at the interior surface of the hole 50 to compact the surface and deter crack initiation. An exemplary peening process is conducted at 9N Almen intensity with 100% coverage. In the illustrated example, a deflector lance 66 is used to deliver the peening media. Other techniques for peening hole bores are known as well.

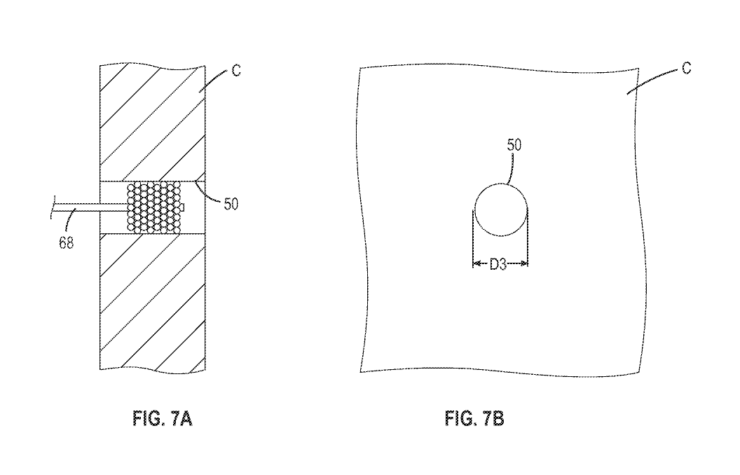

Subsequent to peening, a final machining step is performed on the hole 50, as seen in FIGS. 7A and 7B. A minimal amount of material is removed during this step, bringing the hole 50 to the finished diameter “D3”. In the illustrated example, the machining is performed with a ball flex hone 68 of a known type. The degree of material removal is sufficient to remove any machining marks or undesirable structures such as cracked carbides, while not defeating the effect of the surface compaction from the shot peening step. An exemplary degree of material removal from the surface is about 0.0076 mm (0.0003 in.).

The finished hole 50, after being subjected to the specific combination of processes described above, has a significantly improved low-cycle fatigue life, considering both crack initiation and crack propagation. Testing has shown that the method described herein can improve crack initiation life by a factor of two and crack propagation life by factor of five, compared to component with an untreated hole. This is possible without adding component weight or changing the component material.

The foregoing has described a method of forming and treating holes in metallic components. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A method of treating a hole in a metallic component, comprising the following steps in sequence:
forming an hole having a first diameter in the component;
expanding the hole to a second diameter using a cold expansion process, so as to induce residual compressive stresses in the material surrounding the hole;
shot peening the hole; and
final machining the hole to a finished diameter.

2. The method of claim 1 wherein the cold expansion process is performed using a sleeve having at least one longitudinal split therein.

3. The method of claim 2 wherein, during the step of expanding the hole, the sleeve is oriented such that the at least one longitudinal split is positioned at about 45 degrees from a location of expected peak stress in the hole.

4. The method of claim 2 further comprising, after the step of expanding the hole, machining the hole to remove excess material extruded by the cold expansion process;

5. The method of claim 4 wherein the step of machining to remove excess material comprises reaming

6. The method of claim 1 wherein the step of final machining comprises a flex honing process.

7. The method of claim 1 wherein the step of forming a hole comprises drilling.

8. An aerospace component comprising at least one hole formed therein, the hole formed by the following steps in sequence:
forming a hole having a first diameter in the component;
expanding the hole to a second diameter using a cold expansion process, so as to induce residual compressive stresses in the material surrounding the hole;
shot peening the hole; and
final machining the hole to a finished diameter.

9. The method of claim 8 wherein the cold expansion process is performed using a sleeve having at least one longitudinal split therein.

10. The method of claim 9 wherein, during the step of expanding the hole, the sleeve is oriented such that the at least one longitudinal split is positioned at about 45 degrees from a location of expected peak hoop stress in the hole.

11. The method of claim 9 comprising, after the step of expanding the hole, machining the hole to remove excess material extruded by the cold expansion process;

12. The aerospace component of claim 6 wherein the step of machining to remove excess material comprises reaming.

13. The aerospace component of claim 8 wherein the step of final machining comprises a honing process.

14. The aerospace component of claim 8 wherein the step of forming hole comprises drilling.

15. The aerospace component of claim 8 wherein the component comprises a nickel-based alloy.
